(19) United States
(12) Patent Application Publication
(10) Pub. No.: US 2025/0253684 A1
(43) Pub. Date: Aug. 7, 2025

(54) BATTERY HEALTH PROTECTION IN FAST-CHARGING LITHIUM ION (Li-ion) BATTERY CHARGING SYSTEMS

(71) Applicant: CIRRUS LOGIC INTERNATIONAL SEMICONDUCTOR LTD., Edinburgh (GB)

(72) Inventors: Markos Koseoglou, Austin, TX (US); Emmanuel A. Marchais, Dripping Springs, TX (US); Jon D. Hendrix, Wimberly, TX (US); John L. Melanson, Austin, TX (US)

(21) Appl. No.: 18/433,885

(22) Filed: Feb. 6, 2024

(51) Int. Cl. H02J 7/00

(52) U.S. Cl. CPC H02J 7/0029; H02J 7/0019; H02J 7/0048; H02J 7/005; H02J 7/00712; H02J 2207/20

(57) ABSTRACT

A battery charging system prevents or reduces deterioration of battery health due to fast-charging. The battery charging system includes a battery composed of one or more re-chargeable cells, a battery charging circuit that controls a charging waveform supplied to the battery, and a detection circuit that detects a decrease in resistance of the battery at an AC signal frequency greater than or equal to 200 Hz. The battery charging circuit controls the charging waveform responsive to an output of the detection circuit. In another battery charging system, the battery has multiple re-chargeable cells. The charging circuit apportions charging waveforms at the cells, and the detection circuit that detects a decrease in resistance of a cell at the AC signal frequency. The battery charging circuit and balancing circuit controls apportioning of the individual charging waveforms responsive to an output of the detection circuit.

### BACKGROUND

### 1. Field of Disclosure

The field of representative embodiments of this disclosure relates to battery charging systems, battery charging methods, and in particular, to a fast-charging battery charging system that protects Lithium-Ion cell health.

### 2. Background

In battery-powered portable devices, such as mobile telephones, tablets, notebook computers, along with other battery-operated devices, battery charging and monitoring systems provide for both off-line and on-line charging of device batteries. Fast-charging systems, which provide rapid restoration of battery charge, are typically controlled by sophisticated algorithms that control both the charging rate and maximum charge applied to the batteries, in order to preserve long-time life of the batteries and the ability of the batteries to deliver sufficient charge, i.e., to maintain battery health. The charging algorithms typically use measures of battery health to determine how fast and how much to charge a battery.

One measure of battery health is the battery direct-current (DC) internal resistance, which has long been used as an indicator of overall battery health and charge state. However, battery DC internal resistance only indicates an amalgamated effect of a number of internal mechanisms that contribute to deteriorated battery health. Therefore, the charging algorithms used in fast-charging Li-ion batteries typically use either a physics-based model (PBM), a battery health degradation detection algorithm, or a combination of both, to determine charging patterns, e.g., to determine charging current levels over time. Recently, measures of alternating-current (AC) internal resistance, i.e., the real component of battery impedance, have been used to evaluate battery health, typically at low frequencies between 1 Hz and 10 Hz, such as those used in dynamic electrochemical impedance spectroscopy (DEIS), which provide indications of battery health degradation within the battery. The charging algorithms use changes in battery impedance and monitoring of charge transfer to monitor battery health and control charging.

While existing battery health monitoring algorithms provide detection of battery health degradation within a battery, they are significantly dependent on a highly variable state of the battery, which includes cell temperature, the state of charge (SOC) of the battery and the state of health (SOH) of the battery, which causes difficulties in evaluating battery health degradation of the battery during charging.

Therefore, it would be advantageous to provide a battery charging system and method of operation that prevent or reduce deterioration of battery health due to fast-charging.

### SUMMARY

The objectives of preventing or reducing degradation of battery health during fast-charging are accomplished in a battery charging system and its method of operation.

The battery charging system includes a battery composed of one or more re-chargeable cells, a battery charging circuit that controls a charging waveform supplied to the battery, and a detection circuit that detects a decrease in resistance of the battery at an AC signal frequency greater than or equal to 200 Hz. The battery charging circuit controls the charging waveform responsive to an output of the detection circuit. The waveform may be, for example, a current or a voltage waveform. Another battery charging system includes a battery composed of multiple re-chargeable cells, a battery charging and balancing circuit that apportions individual charging waveforms supplied to corresponding ones of the multiple re-chargeable cells, and a detection circuit that detects a decrease in resistance of the one of the multiple re-chargeable cells from an increase of a component at an AC signal frequency greater than or equal to 200 Hz. The battery charging and balancing circuit controls apportioning of the individual charging waveforms responsive to an output of the detection circuit.

The summary above is provided for brief explanation and does not restrict the scope of the claims. The description below sets forth example embodiments according to this disclosure. Further embodiments and implementations will be apparent to those having ordinary skill in the art. Persons having ordinary skill in the art will recognize that various equivalent techniques may be applied in lieu of, or in conjunction with, the embodiments discussed below, and all such equivalents are encompassed by the present disclosure.

### BRIEF DESCRIPTION OF THE DRAWINGS

FIG. 1 is a block diagram illustrating an example system 10, in accordance with an embodiment of the disclosure.

FIG. 2 is a block diagram illustrating an example charging control circuit 20A, that may be used to implement charging control circuit 20 in example system 10 of FIG. 1, in accordance with an embodiment of the disclosure.

FIG. 3 is a block diagram illustrating another example charging control circuit 20B, that may be used to implement charging control circuit 20 in example system 10 of FIG. 1, in accordance with another embodiment of the disclosure.

FIG. 4 is a block diagram illustrating a generalized measurement system 30, that may be used within charging control 20 in example system 10 of FIG. 1, in accordance with an embodiment of the disclosure.

FIG. 5 is a simplified schematic diagram illustrating portions of a system 40, in accordance with another embodiment of the disclosure.

FIGS. 6A-6D are graphs depicting corresponding signal waveform diagrams 60A-60D, illustrating example charging signals within example system 10, in accordance with various embodiments of the disclosure.

FIG. 7 is a flowchart illustrating an example of processing within example system 10, in accordance with an embodiment of the disclosure.

FIG. 8A and FIG. 8B are graphs depicting example changes of AC resistance of a battery within example system 10 that may be detected and remediated by example system 10, are shown, in accordance with an embodiment of the disclosure.

### DETAILED DESCRIPTION OF ILLUSTRATIVE EMBODIMENT

The present disclosure encompasses battery charging systems, battery charging circuits, and their methods of operation. A battery charging system prevents or reduces deterioration of battery health due to fast-charging, by monitoring battery resistance, i.e., the real part of the battery impedance, at frequencies at or above 200 Hz and controls charging in response to detected changes in the battery resistance. The battery charging system includes a battery composed of one or more re-chargeable cells, a battery charging circuit that controls a charging waveform supplied to the battery, and a detection circuit that detects a decrease in resistance of the battery at an AC signal frequency greater than or equal to 200 Hz. The battery charging circuit controls the charging waveform responsive to an output of the detection circuit. The waveform may be, for example, a current or a voltage waveform. Another battery charging system includes a battery composed of multiple re-chargeable cells, a battery charging and balancing circuit that apportions individual charging waveforms supplied to corresponding ones of the multiple re-chargeable cells, and a detection circuit that detects a decrease in resistance of the one of the multiple re-chargeable cells from an increase of a component at an AC signal frequency greater than or equal to 200 Hz. The battery charging and balancing circuit controls apportioning of the individual charging waveforms responsive to an output of the detection circuit.

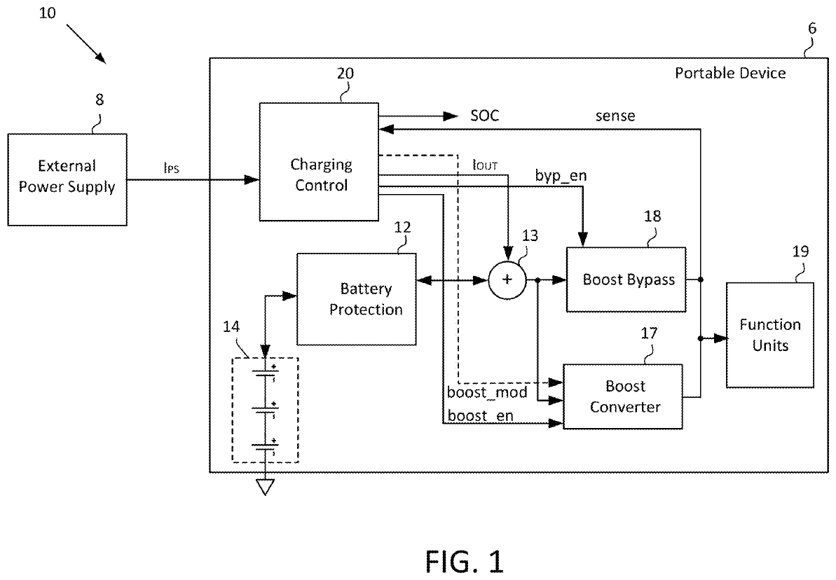

Referring now to FIG. 1, a block diagram illustrating an example system 10 is shown, in accordance with an embodiment of the disclosure. Example system 10 includes an external power supply 8 and a personal device 6 that receives a power supply current I_{PS} and applies the current to operation of portable device and charging of an internal battery 14, which is generally a Li-ion battery. A battery protection circuit 12 provides over-current and over-voltage protection on the connection to battery 14 from a combiner that combines the load of battery charging and the operation of functional units 19, which are coupled to combiner 13 by a power supply path that includes a boost converter 17, which ordinarily operates when the battery output voltage from battery protection circuit 12 is lower than that required by functional units 19, and a boost bypass circuit 18 that directs battery current directly to functional units when battery voltage is sufficient, and generally regulates the voltage provided from battery 14 to functional units 19. Boost converter 17 may also be operated for supplying a modulated current/output voltage that is either in addition to the ordinary output of boost converter 17, or by providing a modulated output current that is combined with the output of boost bypass circuit 18, during measurements performed by a charging control circuit 20 as will be described in further detail below.

Charging control circuit 20, in addition to controlling whether or not boost converter 17 or boost bypass circuit 18 is active during ordinary operation by controlling the state of control signals boost_en and byp_en, respectively, performs measurements to determine the state-of-charge SOC and state-of-health (SOH) of battery 14. In particular, in accordance with various embodiments of the disclosure, charging control circuit applies a modulation to the current or voltage applied to battery 14 during charging, which may be performed intermittently, or continuously, since the modulation amount can generally be quite small with respect to the operating current levels and is of a frequency, e.g., 4 kHz, that is greater than the frequencies generally present in the time variations of the charging current waveform, which is also controlled by charging control circuit 20. Charging control circuit 20 may also set the charging current to a fixed value to which the modulation is added, during measurements. The measurements determine the resistance/detect changes in the resistance of battery 14 at a frequency greater than or equal to 200 Hz. The AC resistance of battery 14 at a given frequency is the real component of the impedance at that frequency, and not the DC resistance alone. Changes in the AC resistance at frequencies greater than or equal to 200 Hz provide a measure of health degradation occurring in a Li-ion battery, which degrades the health of battery 14. By detecting the initial onset of health degradation, charging can be halted or slowed, preventing or reducing degradation in the SOH of battery 14. The AC resistance can be measured as described in further detail below, by measuring battery voltage and current of battery 14 and filtering either the voltage/current ratio (impedance) or by filtering the voltage and current measurements in advance, and computing their ratio. The filtering is generally a narrow band-pass filtering at the modulation frequency. The modulation is controlled by charging control circuit 20 and may be imposed, for example, by applying a modulation to control signal boost_mod to vary the current level at the output of boost converter 17, or by enabling/disabling boost converter 17 at the modulation frequency or a frequency such as an odd sub-harmonic of the desired modulation frequency that will produce sufficient components at the modulation frequency for performing the AC resistance measurement.

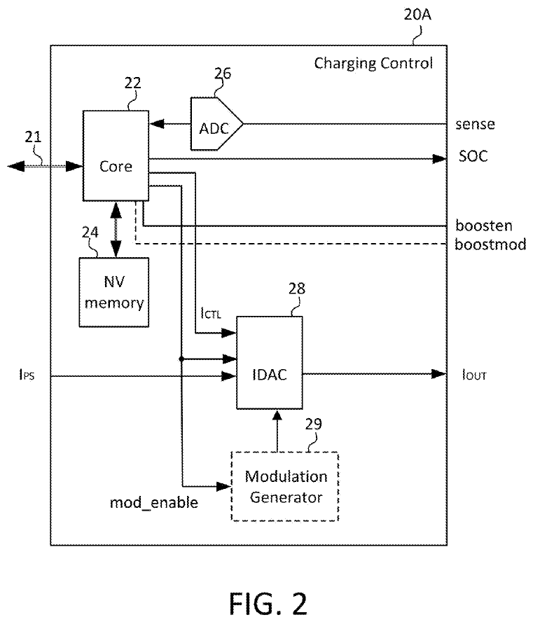

Referring now to FIG. 2, a block diagram illustrating an example charging control circuit 20A, that may be used to implement charging control circuit 20 in example system 10 of FIG. 1 is shown, in accordance with an embodiment of the disclosure. Within charging control circuit 20A, a core 22, which may be a microprocessor core, microcontroller core, state machine, or another suitable processor, implements the measurement and charge control algorithms described herein, in order to modulate the charging current applied to battery 14 in FIG. 1, either by dynamically changing input values supplied to a high-power digitally-controlled current digital-to-analog converter circuit (IDAC) 28, or by enabling an optional modulation generator 29 that modulates the reference current of IDAC by asserting a control signal mod_enable. The result is a modulation at a frequency 200 Hz or above, e.g., 4 kHz or 1 kHz, on output current Jour that supplies charging current to battery 14. For example, at 1 kHz, the measured AC resistance gives a measure of resistance due to the ohmic resistance of the cell plus the ionic resistance of the battery electrolyte. Evaluation of AC resistance at even higher frequencies, e.g., 4 kHz, reveals resistance changes due to other physical changes within the cells of the battery. An analog-to-digital converter (ADC) 26 receives a sense signal sense, which in the instant example, is an indication of the voltage across battery 14, e.g., from a voltage divider connected to the positive terminal of battery 14. Core 22 may be coupled to a non-volatile memory (NV) 24 that may store program code executed by core 22 and forming a computer-program product in accordance with an embodiment of the disclosure to implement the measurement, detection and control algorithms described herein. Core 22 may also compute a measure of the SOC of battery 14 and provide an output SOC used by other subsystems.

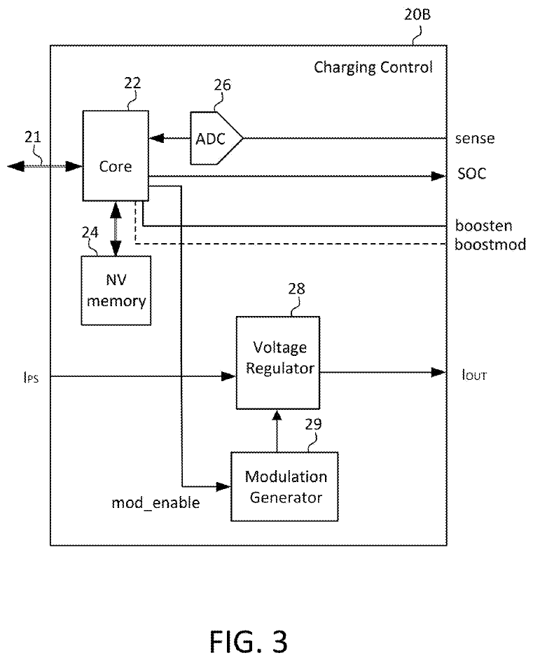

Referring now to FIG. 3, a block diagram illustrating another example charging control circuit 20B, that may be used to implement charging control circuit 20 in example system 10 of FIG. 1 is shown, in accordance with another embodiment of the disclosure. Charging control circuit 20B is similar to charging control circuit 20A of FIG. 2, therefore only differences between them and their operation will be described in further detail below. Within charging control circuit 20B, a voltage regulator 28 supplies a controlled voltage to source output current IOUT and a modulation is imposed on the voltage produced by voltage regulator 28, when control signal mod_enable is asserted to enable modulation generator 29. ADC 26 receives an indication of a current supplied to battery 14, e.g., from a sense resistor that produces a voltage provided as input signal sense, and that is inserted in the path that carries the battery charging current.

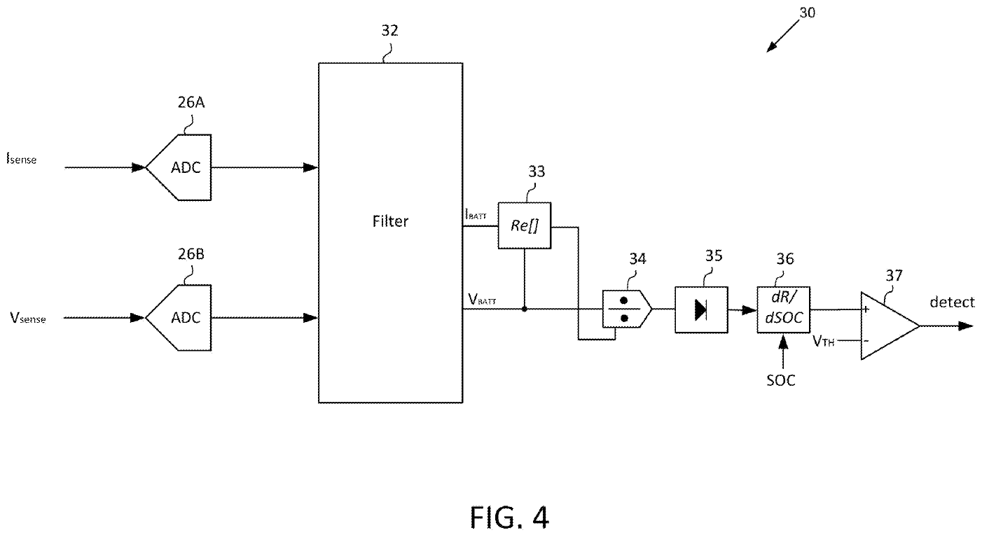

Referring now to FIG. 4, a block diagram illustrating a generalized measurement system 30, that may be used within charging control 20 in example system 10 of FIG. 1 is shown, in accordance with an embodiment of the disclosure. Voltages corresponding to the terminal voltage and current of battery 14 in FIG. 1 are provided to a pair of analog-to-digital converters 26A, 26B, which provide inputs to a digital filter 32 that filters the resulting voltage and current values with a band-pass characteristic centered around the modulation frequency F_{TEST} and that may, along with subsequent processing blocks, be implemented by a program executed by core 22 within charging control circuit 20A of FIG. 2 or charging control circuit 20B of FIG. 3. Alternatively, digital filter 32 and subsequent processing blocks may be implemented by a dedicated circuit. A function block 33 produces an output corresponding to the real part of the filtered representation of battery current I_{BATT}, i.e., the component of battery current I_{BATT} that is in-phase with the filtered representation of battery terminal voltage VBATT, since the outputs of digital filter 32 are essentially sinusoids. A divider 34 computes the battery AC resistance, i.e., VBATT/Re [I_{BATT}] and a detector 35, which may be a peak or average detector, smooths the output of divider, which is then differentiated/change detected with respect to stage of charge indication SOC by a differentiator 36 to provide an indication of a rate of change of the AC resistance of battery 14 with respect to SOC. A comparator compares the rate of change of AC resistance with respect to SOC to a threshold and detects when the rate of change drops below a negative threshold—V_{TH}, indicating that the AC resistance of battery 14 at frequency F_{TEST} is decreasing rapidly with respect to SOC, indicating that battery health degradation is occurring. The resulting output signal detect may then be used by charging control circuit 20A or 20B to cease fast-charging of battery 14, by interrupting or reducing the charging current applied to battery 14.

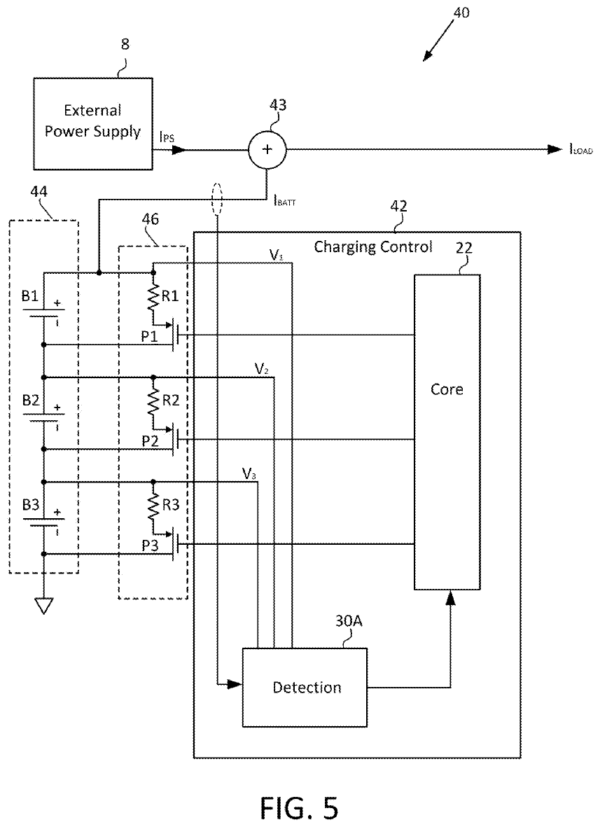

Referring now to FIG. 5, a simplified schematic diagram illustrating portions of a system 40 is shown, in accordance with another embodiment of the disclosure. External power supply 8 and current combiner 43 provide charging current to a multi-cell battery 44 that is coupled to a balancing circuit 46 that is implemented by resistors R1-R3 and associated transistors P1-P3, and which have gates controlled by core 22 within a charging control circuit 42. Transistors P1-P3 are activated intermittently to balance terminal voltages V₁, V₂, and V₃ of corresponding cells B1, B2 and B3 of battery, according to a balancing algorithm, such as a battery balancing algorithm as well-known in the art. However, the balancing performed by example charging circuit 42 and balancing circuit 46 is performed at a rate that causes battery current I_{BATT} to have a component at modulation frequency F_{TEST}, so that measurement, detection and control, such as the techniques described above, may be performed without requiring a separate modulation source.

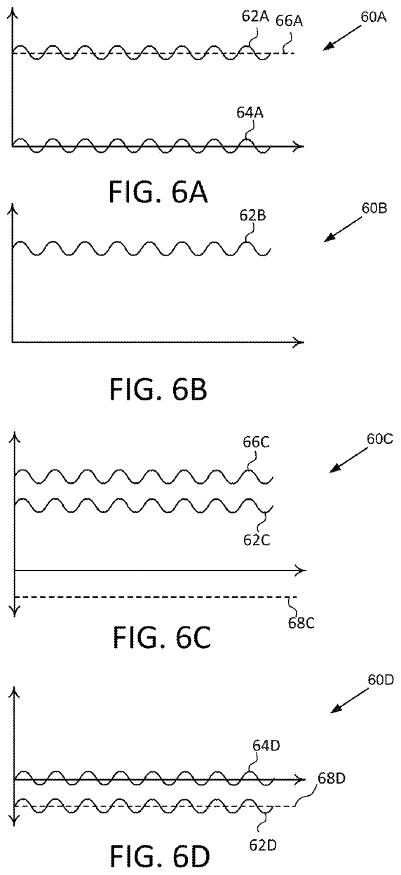

Referring now to FIGS. 6A-6D, graphs depict corresponding signal waveform diagrams 60A-60D, illustrating example charging signals within example system 10 are shown, in accordance with various embodiments of the disclosure. Graph 60A in FIG. 6A illustrates an implementation or operating mode in which boost converter 17 is operated with modulation while no load current is present, to produce a modulated current illustrated by waveform 64A. The modulated boost converter output current combines with a DC charging current, shown in waveform 66A, to produce a resulting battery charging current shown in waveform 62A. Graph 60B in FIG. 6B illustrates an implementation or operating mode in which the charging current is modulated directly and load current is absent, so that the battery current, illustrated by waveform 62B, is equal to the modulated charging current. Graph 60C in FIG. 6C illustrates an implementation or operating mode in which the charging current, illustrated by waveform 66C, is modulated directly, while a load current, illustrated by waveform 68C, combines with the DC charging current to produce a resulting battery charging current shown in waveform 62C. Graph 60D in FIG. 6D illustrates an implementation or operating mode in which boost converter 17 is operated with modulation while load current, illustrated by waveform 68D, is present. The load current combines with the modulated boost converter output current to produce the battery current illustrated by waveform 62D.

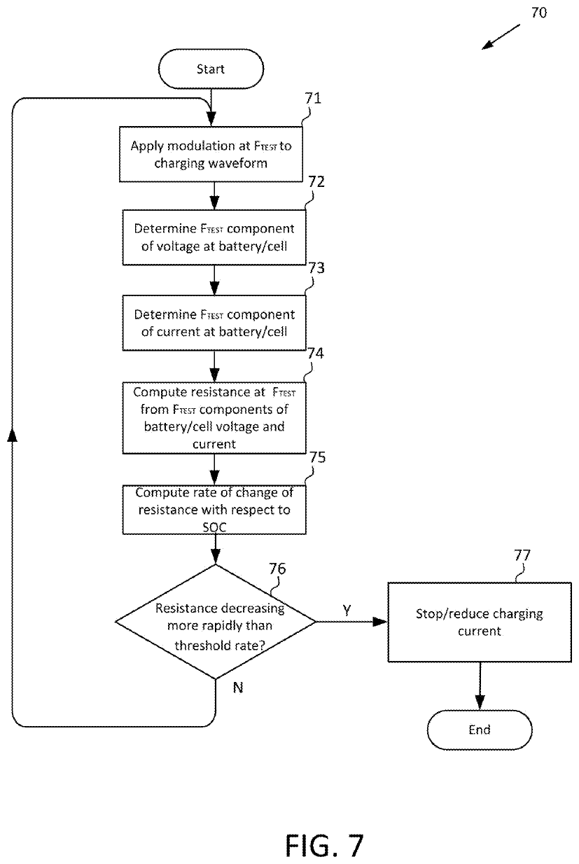

Referring now to FIG. 7, a flowchart 70 illustrating an example of processing within example system 10 is shown, in accordance with an embodiment of the disclosure. Flowchart 70 is an example of an algorithm that may be implemented by the above-described computer program product executed by core 22 in example charging control circuits 20A, 20B of FIGS. 2-3. Modulation is applied at frequency F_{TEST} to the charging waveform (step 71). The component of battery terminal voltage at frequency F_{TEST} is determined (step 72), and the component of battery current at frequency F_{TEST} is determined (step 73). The resistance at frequency F_{TEST} is computed (step 74) from the battery voltage and battery current components at frequency F_{TEST} that were determined in steps 72-73. The rate-of-change of the resistance with respect to SOC is computed (step 75) and compared to determine if the resistance is decreasing more rapidly with respect to SOC than a threshold rate (decision 76). If the rate of decrease of resistance is more rapid than the threshold rate (decision 76), then charging is stopped or the charging current is reduced (step 77) to prevent or reduce health degradation in the battery.

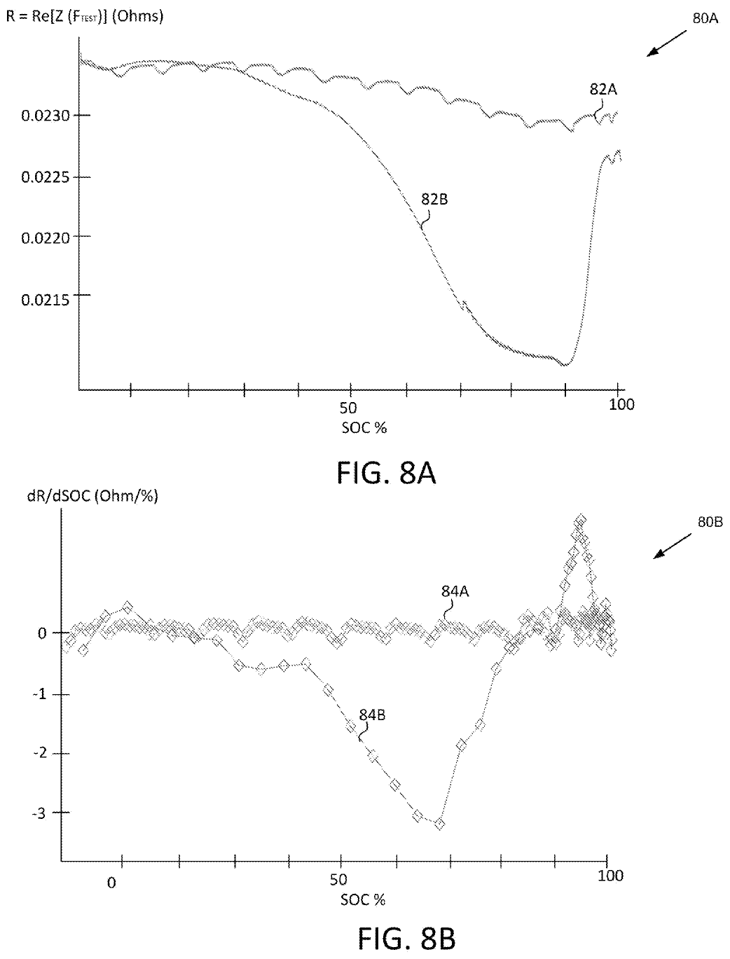

Referring now to FIG. 8A and FIG. 8B, graphs depicting example changes of AC resistance of a battery within example system 10 that may be detected and remediated by example system 10, are shown, in accordance with an embodiment of the disclosure. FIG. 8A shows a graph 80A with battery AC resistance at a frequency of 4 kHz vs. SOC shown during slow charging in curve 82A and during fast-charging in curve 82B. During the fast-charging example, as the SOC exceeds 40%, a dramatic drop in AC resistance is seen between 50% and 90% SOC. In the slow charging example shown in curve 82A, the AC resistance does shift, but not to the degree exhibited by the AC resistance change shown in curve 82B. FIG. 8B shows the time derivative of curves 82A and 82B in corresponding curves 84A and 84B, for a constant (lower) slow charge battery current and for a constant (higher) fast-charge battery current.

As mentioned above, portions or all of the disclosed process may be carried out by a state machine, which may be provided by a logic circuit, or the execution of a collection of program instructions forming a computer program product stored on a non-volatile memory, and executed by a controller core. Such programs may also exist outside of the non-volatile memory in tangible forms of storage forming a computer-readable storage medium. The computer-readable storage medium may be, for example, but is not limited to, an electronic storage device, a magnetic storage device, an optical storage device, an electromagnetic storage device, a semiconductor storage device, or any suitable combination of the foregoing. Specific examples of the computer-readable storage medium include the following: a hard disk, semiconductor volatile and non-volatile memory devices, a portable compact disc read-only memory (CD-ROM) or a digital versatile disk (DVD), a memory stick, a floppy disk or other suitable storage device not specifically enumerated. A computer-readable storage medium, as used herein, is not to be construed as being transitory signals, such as transmission line or radio waves or electrical signals transmitted through a wire. It is understood that blocks of the block diagrams described above may be implemented by computer-readable program instructions. These computer readable program instructions may also be stored in other storage forms as mentioned above and may be downloaded into a non-volatile memory for execution therefrom. However, the collection of instructions stored on media other than the non-volatile memory described above also form a computer program product that is an article of manufacture including instructions which implement aspects of the functions/actions specified in the block diagram block or blocks, as well as method steps described herein.

It should be understood, especially by those having ordinary skill in the art with the benefit of this disclosure, that the various operations described herein, particularly in connection with the figures, may be implemented by other circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense. Similarly, although this disclosure makes reference to specific embodiments, certain modifications and changes may be made to those embodiments without departing from the scope and coverage of this disclosure. Moreover, any benefits, advantages, or solutions to problems that are described herein with regard to specific embodiments are not intended to be construed as a critical, required, or essential feature or element.

In summary, this disclosure shows and describes circuits, methods of operation, and circuits that include a battery composed of one or more re-chargeable cells, a battery charging circuit that controls a charging waveform supplied to the battery, and a detection circuit that detects a decrease in resistance of the battery at an AC signal frequency greater than or equal to 200 Hz. The battery charging circuit may control the charging waveform responsive to an output of the detection circuit.

In some example embodiments, the system may further include a modulation circuit that superimposes an AC signal having the AC signal frequency on the charging waveform, and the detection circuit may detect the decrease in resistance of the battery from an increase of a component of the charging waveform due to the superimposed AC signal. The modulation may be included in the battery charging circuit and may superimpose the AC signal by modulating the charging waveform directly, or the modulation circuit may be a modulated boost converter that superimposes the AC signal by adding the AC signal to the charging waveform. In some example embodiments, the one or more cells may be a plurality of re-chargeable cells. The battery charging circuit may include a balancing circuit that apportions individual charging waveforms supplied to corresponding ones of the plurality of re-chargeable cells, and the modulation circuit may modulate the balancing circuit to superimpose the AC signal on one or more of the individual charging waveforms.

In some example embodiments, the battery charging circuit may, in response to the detection circuit detecting the decrease in resistance, reduce a magnitude of the charging waveform to protect battery health. In some example embodiments, wherein the detection circuit may detect the decrease in resistance of the battery by comparing a measured resistance to a nominal resistance value for the battery. In some example embodiments, the detection circuit may differentiate the measure of determined resistance of the battery with respect to SOC to provide an indicator of battery health degradation. In some example embodiments, the AC signal frequency may be greater than or equal to 1 kHz. In some example embodiments, the AC signal frequency is substantially equal to 1 kHz, whereby changes in ohmic resistance and ionic resistance of electrolyte in the battery are detected by the detection circuit.

This disclosure also shows and describes circuits, methods of operation, and circuits that include a battery composed of multiple re-chargeable cells, a battery charging and balancing circuit that apportions individual charging waveforms supplied to corresponding ones of the multiple re-chargeable cells, and a detection circuit that detects a decrease in resistance of the one of the multiple re-chargeable cells from an increase of a component at an AC signal frequency greater than or equal to 200H. The battery charging and balancing circuit may control apportioning of the individual charging waveforms responsive to an output of the detection circuit. In some example embodiments, the battery charging and balancing circuit may include a modulation circuit for superimposing an AC signal on the charging waveforms, and the detection circuit may detect the decrease in resistance of the one of the multiple re-chargeable cells from an increase of a component of a corresponding one of the charging waveforms due to the superimposed AC signal.

While the disclosure has shown and described particular embodiments of the techniques disclosed herein, it will be understood by those skilled in the art that the foregoing and other changes in form, and details may be made therein without departing from the spirit and scope of the disclosure. For example, the techniques shown above may be applied to other types of battery chargers for other types of batteries.

What is claimed is:

1. A system, comprising:
a battery charging circuit that controls a charging waveform to supply to a battery; and
a detection circuit that detects a decrease in resistance of the battery at an AC signal frequency greater than or equal to 200 Hz, wherein the battery charging circuit controls the charging waveform responsive to an output of the detection circuit.

2. The system of claim 1, further comprising a battery composed of one or more re-chargeable cells.

3. The system of claim 1, further comprising a modulation circuit that superimposes an AC signal having the AC signal frequency on the charging waveform, and wherein the detection circuit detects the decrease in resistance of the battery from an increase of a component of the charging waveform due to the superimposed AC signal.

4. The system of claim 3, wherein the modulation circuit is included in the battery charging circuit and superimposes the AC signal by modulating the charging waveform directly.

5. The system of claim 3, wherein the modulation circuit is a modulated boost converter that superimposes the AC signal by adding the AC signal to the charging waveform.

6. The system of claim 3, wherein the battery is composed of a plurality of re-chargeable cells, wherein the battery charging circuit includes a balancing circuit that apportions individual charging waveforms supplied to corresponding ones of the plurality of re-chargeable cells, and wherein the modulation circuit modulates the balancing circuit to superimpose the AC signal on one or more of the individual charging waveforms.

7. The system of claim 1, wherein the battery charging circuit, in response to the detection circuit detecting the decrease in resistance, reduces a magnitude of the charging waveform to protect battery health.

8. The system of claim 1, wherein the detection circuit detects the decrease in resistance of the battery by comparing a measured resistance to a nominal resistance value for the battery.

9. The system of claim 1, wherein the detection circuit differentiates the measure of determined resistance of the battery with respect to a state of charge of the battery to provide an indicator of battery health degradation.

10. The system of claim 1, wherein the AC signal frequency is greater than or equal to 1 kHz.

11. The system of claim 10, wherein the AC signal frequency is substantially equal to 1 kHz, whereby changes in ohmic resistance and ionic resistance of electrolyte in the battery are detected by the detection circuit.

12. A system, comprising:
a battery charging and balancing circuit that apportions individual charging waveforms supplied to corresponding ones of multiple re-chargeable cells of a battery; and
a detection circuit that detects a decrease in resistance of one of the multiple re-chargeable cells from an increase of a component at an AC signal frequency greater than or equal to 200 Hz, wherein the battery charging circuit and balancing circuit controls apportioning of the individual charging waveforms responsive to an output of the detection circuit.

13. The system of claim 12, wherein the battery charging and balancing circuit includes a modulation circuit that superimposes an AC signal on the charging waveforms, and wherein the detection circuit detects the decrease in resistance of the one of the multiple re-chargeable cells from an increase of a component of a corresponding one of the charging waveforms due to the superimposed AC signal.

14. The system of claim 12, wherein the AC signal frequency is greater than or equal to 1 kHz.

15. The system of claim 14, wherein the AC signal frequency is substantially equal to 1 kHz, whereby changes in ohmic resistance and ionic resistance of electrolyte in the battery are detected by the detection circuit.

16. A method of detecting changes in a battery composed of one or more re-chargeable cells, the method comprising:
controlling a charging waveform supplied to a battery; and
detecting a decrease in resistance of the battery at an AC signal frequency greater than or equal to 200 Hz, and wherein the controlling controls the charging waveform responsive to a result of the detecting.

17. The method of 16, further comprising superimposing an AC signal having the AC signal frequency on the charging waveform, and wherein the detecting detects the decrease in resistance of the battery from an increase of a component of the charging waveform due to the superimposed AC signal.

18. The method of claim 17, wherein the superimposing modulates the charging waveform directly.

19. The method of claim 17, further comprising:
generating the AC signal with a modulated boost converter; and
combining an output of the modulated boost converter with the charging waveform.

20. The method of claim 17, wherein the one or more cells is a plurality of re-chargeable cells, wherein the method further comprises apportioning individual charging waveforms supplied to corresponding ones of the plurality of re-chargeable cells, and wherein the modulating modulates the balancing circuit to superimpose the AC signal on one or more of the individual charging waveforms.

21. The method of claim 16, further comprising responsive to detecting the decrease in resistance, reducing a magnitude of the charging waveform to protect battery health.

22. The method of claim 16, wherein the detecting detects the decrease in resistance of the battery by comparing a measured resistance to a nominal resistance value for the battery.

23. The method of claim 16, further comprising differentiating the measure of determined resistance of the battery with respect to a state-of-charge of the battery to provide an indicator of battery health degradation.

24. The method of claim 16, wherein the AC signal frequency is greater than or equal to 1 kHz.

25. The method of claim 24, wherein the AC signal frequency is substantially equal to 1 kHz, whereby changes in ohmic resistance and ionic resistance of electrolyte in the battery are detected by the detecting.

26. A method of detecting changes in a battery composed of multiple re-chargeable cells, the method comprising:
apportioning individual charging waveforms supplied to corresponding ones of the multiple re-chargeable cells; and
detecting a decrease in resistance of one of the multiple re-chargeable cells at an AC signal frequency greater than or equal to 200 Hz, and wherein the controlling controls the apportioning of the individual charging waveform responsive to a result of the detecting.

27. The method of claim 26, further comprising superimposing an AC signal on the charging waveforms, and wherein the detecting detects the decrease in resistance of the one of the multiple re-chargeable cells from an increase of a component of a corresponding one of the charging waveforms due to the superimposed AC signal.

28. The method of claim 26, wherein the AC signal frequency is greater than or equal to 1 kHz.

29. The method of claim 28, wherein the AC signal frequency is substantially equal to 1 kHz, whereby changes in ohmic resistance and ionic resistance of electrolyte in the battery are detected by the detection circuit.
